(19) United States
(12) Patent Application Publication
(10) Pub. No.: US 2011/0275434 A1
(43) Pub. Date: Nov. 10, 2011

(54) METHODS FOR CONTROLLING A PROCESS OF A GAME AND ELECTRONIC DEVICES UTILIZING THE SAME

(75) Inventors: Yiou-Wen Cheng, Taipei County (TW); Wen-Chih Chen, Taipei City (TW); Hsin-Te Shih, Taipei County (TW)

(73) Assignee: MEDIATEK INC., Hsin-Chu (TW)

(21) Appl. No.: 12/773,155

(22) Filed: May 4, 2010

(51) Int. Cl. A63F 9/24; H04R 3/00

(52) U.S. Cl. 463/36; 381/92

(57) ABSTRACT

An electronic device comprises a microphone array, a signal processor and a game controller. The microphone array comprises at least a first microphone unit for capturing at least a first acoustic signal and a second microphone unit for capturing at least a second acoustic signal. The signal processor processes the first and second acoustic signals and obtains at least one characteristic from the first and second acoustic signals. The game controller updates at least one parameter of a game in accordance with the at least one characteristic; thereby controlling a process of the game.

### BACKGROUND OF THE INVENTION

1. Field of the Invention

The invention relates to a method for controlling a process of a game installed in an electronic device, and more particularly to a method for controlling a process of a game by using acoustic signals captured by the electronic device.

2. Description of the Related Art

Mobile phones have become a very commonly used personal portable electronic device nowadays. In addition to the purposes of simply making and receiving telephone calls and sending and receiving short messages, plenty of entertainment applications provided by the mobile phones are also available to the users. The variety of the entertainment applications is now another important factor considered by the users when they are choosing a mobile phone. For example, almost every mobile phone had a build-in MP3 player, camera or java game.

For game or java game applications, the most common way for the user to control a playable character or object in the game is via the keypad or touch screen. For example, different keys of the keypad correspond to different instructions for controlling the game. The user may govern the movement/actions of a playable object or otherwise influence the events in the game by pressing the keys on the keypad.

The release announcement of Nintendo's Wii system caused a sensation as it brings a new form of player interaction. Wii remote uses accelerometers and infrared detection to detect the approximate orientation and acceleration so it can be used as a pointing device to control movement/actions of a playable object. A new player interaction method for portable electronic device such as mobile phones and a great variety of games developed therewith should also be very attractive to users.

### BRIEF SUMMARY OF THE INVENTION

Electronic devices and methods for controlling a process of a game installed in an electronic device with a microphone array are provided. The game is defined as an electronic game that involves interaction with a user interface to generate visual or audio feedback in this invention. An embodiment of an electronic device comprises a microphone array, a signal processor and a game controller. The microphone array comprises at least a first microphone unit for capturing at least a first acoustic signal and a second microphone unit for capturing at least a second acoustic signal. The signal processor processes the first and the second acoustic signals and obtains at least one characteristic from the first and second acoustic signals. The game controller updates at least one parameter of a game in accordance with the at least one characteristic; thereby controlling a process of the game.

An embodiment of a method for controlling a process of a game installed in an electronic device with a microphone array comprises: receiving a plurality of acoustic signals via the microphone array as input signals of the game; processing the acoustic signals to obtain at least one characteristic from the acoustic signals; and updating at least one parameter of the game in accordance with the at least one characteristic; thereby controlling the process of the game.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

Table 1 shows an example of the correct answers of the drumming operations of the game.

FIG. 1 shows an electronic device 100 according to an embodiment of the invention;

FIG. 2 is a schematic diagram showing the concept of obtaining the direction of a sound source generating the acoustic signals according to an embodiment of the invention;

FIG. 3 is a schematic diagram showing the concept of obtaining the distance from the microphone array to the sound source generating the acoustic signals according to an embodiment of the invention;

FIG. 4 is a schematic diagram showing the concept of obtaining a velocity of a moving sound source according to an embodiment of the invention;

FIG. 5 shows an exemplary game installed in the electronic device that receives the acoustic signals as the input signals according to an embodiment of the invention;

FIG. 6 illustrates a signal processing flow for processing the input acoustic signal of the virtual drumming game according to an embodiment of the invention;

FIG. 7a shows an exemplary scene of the game to be displayed on the screen for indicating the player what are the expected drumming operations according to the correct answers shown in Table 1;

FIG. 7b shows an exemplary scene of the game to be displayed on the screen for indicating the player that the correct drums were hit in time;

FIG. 7c shows an exemplary scene of the game to be displayed on the screen for indicating the player that the drums were not correctly hit in time;

FIG. 8 shows a flow chart of a method for controlling the process of a virtual drumming game according to an embodiment of the invention;

FIG. 9 shows another exemplary game installed in the electronic device that receives the acoustic signals as the input signals according to another embodiment of the invention;

FIG. 10 illustrates a signal processing flow for processing the input acoustic signal of the virtual pet breeding game according to an embodiment of the invention;

FIG. 11 shows a flow chart of a method for controlling the process of a virtual pet breeding game according to an embodiment of the invention;

FIG. 12 shows another exemplary game installed in the electronic device that receives the acoustic signals as the input signals according to another embodiment of the invention;

FIG. 13 illustrates a signal processing flow for processing the input acoustic signal of the sound judger game according to an embodiment of the invention; and

FIG. 14 shows a flow chart of a method for controlling the process of a sound judger game according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

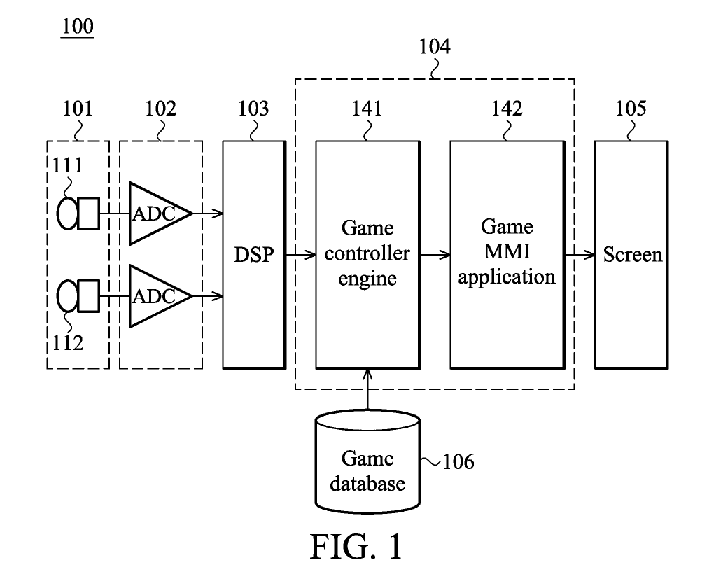

FIG. 1 shows an electronic device 100 according to an embodiment of the invention. The electronic device 100 may be installed in a portable electronic device, such as a notebook, a cellular phone, a portable gaming device, a portable multimedia player, a Global Positioning System (GPS), a receiver, or others. As shown in FIG. 1, the electronic device 100 comprises a microphone array 101, an analog to digital conversion module 102, a signal processor 103, a game controller 104 and a screen 105. The microphone array 101 may comprise a plurality of microphone units for picking up or capturing acoustic signals coming from different directions within different ranges. For simplicity, two microphone units are illustrated here as the embodiment shown in FIG. 1. However, the invention is not limited to any predetermined number of microphone units. The microphone array 101 comprises a first microphone unit 111 for capturing at least a first acoustic signal generated within a first range and a second microphone unit 112 for capturing at least a second acoustic signal generated within a second range, wherein the first range and the second range may or may not overlap with each other. For example, the first microphone unit 111 may be located on the left side of the electronic device 100 for capturing the acoustic signals coming from the left side of the electronic device 100, and the second microphone unit 112 may be located on the right side of the electronic device 100 for capturing the acoustic signals coming from the right side of the electronic device 100. Note that the left and right sides configuration is simply an example of possible configurations and the invention should not be limited thereto.

The acoustic signals captured by the microphone array 101 are then passed to the analog to digital conversion module 102. The analog to digital conversion module 102 may comprise a plurality of analog to digital converters (ADCs). As the example shows in FIG. 1, the analog to digital conversion module 102 may comprise two ADCs, each in one signal processing path for converting the acoustic signal captured by the corresponding microphone unit from analog to digital. The signal processor 103 may be a digital signal processor (DSP) for processing the digitized acoustic signals as shown in FIG. 1. According to an embodiment of the invention, the signal processor 103 analyzes the acoustic signals and obtains at least one characteristic from the acoustic signals. Further details of the acoustic signal analysis are presented and discussed in the following paragraphs and subsequent figures.

The game controller 104 controls the process of games installed in the electronic device 100, and controls the screen 105 to display the scenes of the game, accordingly. The games installed in the electronic device 100 may receive the acoustic signals as the input signals. To be more specific, the user (player) may generate sounds as instructions for controlling the game. For example, a game processes beating or drumming sounds performed by a user as input signals. The user (player) may drum the table with his fingertips or by using something like pens or sticks so as to generate the sounds. After the signal processor 103 analyzes and obtains the characteristics from the acoustic signals, the information is passed to the game controller 104. As shown in FIG. 1, the game controller 104 may further comprise a game controller engine 141 for controlling the process of the game and a game MMI (man-machine interface) application unit 142 for controlling the drawing of the scenes of the game so as to provide an interface for player interaction. The game controller 104 may be a general-purposed processing unit or a microcontroller unit (MCU), or others, loads and executes program code or instructions to perform operations of the game controller engine 141 and the game MMI application unit 142. The game controller engine 141 of the game controller 104 may update at least one parameter of the game in accordance with the characteristic. The parameter of the game may at least comprise, as an example, a score or record of the game, an instruction recognized in accordance with the characteristic for controlling the game, a position of an object of the game to be displayed on the screen 105, or any other parameters relating to the game. For example, the game controller engine 141 may update the score or record of the game, change the status of the game, or update the position of the object of the game to be displayed on the screen in accordance with the characteristic, and the game MMI application unit 142 of game controller 104 may refresh the scenes of the game displayed on the screen 105 in response to the updated parameter so as to display the new score, new record, new position, or any other status change of the game on the screen 105. Further details of controlling the game processes are presented and discussed in the following paragraphs and subsequent figures.

According to an embodiment of the invention, the characteristic from the acoustic signals at least comprises a time difference of arrival (TDOA) between an acoustic signal captured by the microphone unit 111 and an acoustic signal captured by another microphone unit 112, a direction of at least a sound source generating the acoustic signals, a distance from the microphone array to the sound source, and/or a position of the sound source. According to an embodiment of the invention, the signal processor 103 may obtain the time difference of arrival between two acoustic signals at the microphone array 101 according to a cross-correlation therebetween. The cross-correlation function is defined by:

Rₓ_{₁}_{,x}_{₂}(τ)=E{x₁(n)x₂(n+τ)} Eq. (1)

where x₁(n) represents the acoustic signal captured by the microphone unit 111, x₂(n) represents the acoustic signal captured by the microphone unit 112 and the argument τ represents the time difference therebetween. In general, a higher level of the correlation means that the argument τ is relatively close to the actual time difference of arrival (TDOA) between the acoustic signals captured by the different microphone units.

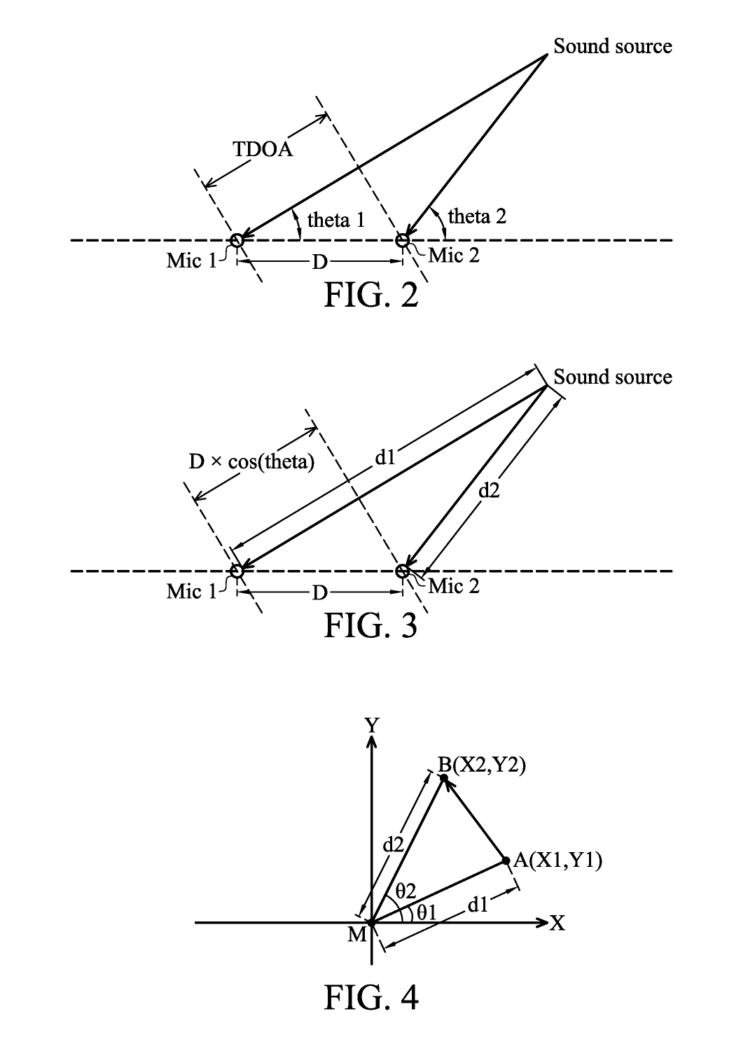

FIG. 2 is a schematic diagram showing the concept of obtaining the direction of a sound source generating the acoustic signals according to an embodiment of the invention. In the embodiment of the invention, the signal processor 103 may obtain the direction of a sound source by determining incident angles of the acoustic signals according to the time difference of arrival. As shown in FIG. 2, the incident angle of the acoustic signal captured by the microphone unit (Mic 1) is theta 1, the incident angle of the acoustic signal captured by the microphone unit (Mic 2) is theta 2 and the distance between the microphone units Mic 1 and Mic 2 is D. Suppose that, as compared to the distance D between the microphone units Mic 1 and Mic 2, the sound source is far away from the microphone array. The incident angles of the acoustic signals captured by the different microphone units would almost be the same and may be expressed by:

theta 1=theta 2=theta Eq. (2)

Based on the obtained TDOA between the acoustic signals captured by the different microphone units Mic 1 and Mic 2 as shown in Eq. (1), the direction of the sound source (i.e. the incident angle: theta) may be obtained by:

theta=cos⁻¹(TDOA/D) Eq. (3)

where TDOA is the argument τ with the maximum cross-correlation between the two acoustic signals as shown in Eq. (1).

FIG. 3 is a schematic diagram showing the concept of obtaining the distance from the microphone array to the sound source generating the acoustic signals according to an embodiment of the invention. In the embodiment of the invention, the signal processor 103 may obtain the distance from the microphone array to the sound source according to the direction of the sound source as obtained in Eq. (3), amplitudes of the acoustic signals respectively captured by the microphone units Mic 1 and Mic 2, and the distance D between the microphone units. Because the energy of the acoustic signals is inversely proportional to the propagation distance, the relationship between the distance and signal energy may be derived as:

d1×p1=d2×p2 Eq. (4)

where d1 represents the distance between the sound source and the microphone unit Mic 1, d2 represents the distance between the sound source and the microphone unit Mic 2, p1 represents the energy (or sound pressure) of the acoustic signal captured by the microphone unit Mic 1, and p2 represents the energy (or sound pressure) of the acoustic signal captured by the microphone unit Mic 2. As shown in FIG. 3, since the sound source is supposed to be far away from the microphone array, the distance d2 may be derived by:

d2=d1−D×cos(theta) Eq. (5)

where theta=theta 1=theta 2 as shown in Eq. (2). Take Eq. (5) into Eq. (4) and derive

d1×p1=(d1−D×cos(theta))×p2 Eq. (6)

Therefore, the distance d1 may be obtained by:

d1=D×cos(theta)×p2/(p2−p1) Eq. (7)

Note that the energy (or sound pressure) p1 and p2 of the acoustic signals may be obtained according to the amplitudes of the corresponding acoustic signals. As an example, the energy (or sound pressure) of the acoustic signals may be obtained according to a square of the amplitudes of the corresponding acoustic signals.

Since the direction of the sound source and the distance from the microphone array to the sound source may be obtained as shown in Eq. (3) and Eq. (7), the signal processor 103 may further obtain the position of the sound source according to the direction of and the distance from the microphone array to the sound source. As shown in FIG. 4, when the sound source is at position A, the coordinates X1 and Y1 of the position A may be expressed as:

X1=d1×cos θ1 Eq. (8)

Y1=d1×sin θ1 Eq. (9)

where the central point M(0,0) represents the central point of the microphone array, d1 is the distance from the microphone array to the sound source and θ1 is the incident angle of the sound source when the sound source is at position A. According to an embodiment of the invention, once the position of the sound source is determined, the velocity and acceleration of a moving sound source may further be estimated accordingly. FIG. 4 is a schematic diagram showing the concept of obtaining a velocity of a moving sound source according to an embodiment of the invention. Suppose that the sound source moves from position A to position B, the velocity V of the moving sound source may be derived by:

V=\sqrt{(X2−X1)²+(Y2−Y1)²}/(T2−T1) Eq. (10)

where T1 is the time when the sound source moves to position A and T2 is the time when the sound source moves to position B, and where coordinates X2 and Y2 of the position B may be expressed by:

X2=d2×cos θ2 Eq. (11)

Y2=d2×sin θ2 Eq. (12)

where d2 is the distance from the microphone array to the sound source when the sound source is at position B, and θ2 is the incident angle of the sound source.

According to the embodiments of the invention, since the velocity of the moving sound source may vary with time, the signal processor 103 may continue to track the velocity of the moving sound source, and further obtain an acceleration a of the moving sound source as below:

a=(V2−V1)/(estimation_time_interval) Eq. (13)

where V1 represents the velocity of the moving sound source estimated at a first time, V2 represents the velocity of the moving sound source estimated at a second time, and estimation_time_interval represents the time interval between the first time and the second time.

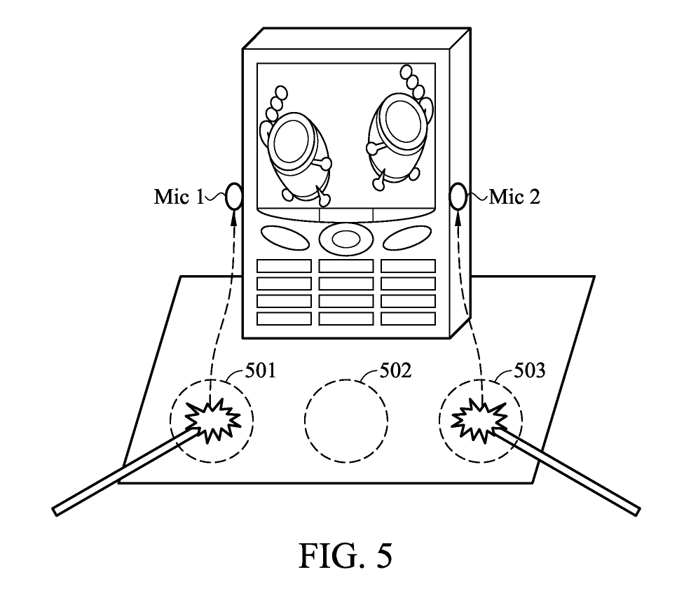

FIG. 5 shows an exemplary game installed in the electronic device that receives acoustic signals as the input signals according to an embodiment of the invention. In the embodiment, the electronic device 100 is installed in a communication apparatus, such as a cellular phone, and the game may be a virtual drumming game, such as the well-known game: Taiko Drum Master, which is a drumming game for Sony PlayStation 2. The player plays the drum in time with music. When the player's timing of the drumbeat is perfect (or within an interval), score will be incremented. On the contrary, when the player's timing of the drumbeat is less accurate, or the player missed the drumbeat entirely, score will not be incremented, or will even be deducted. According to the embodiment of the invention, instead of using the keys on the keypad to simulate the drumming operations, the player generates sounds that will be captured by the microphone array of the electronic device to represents the drumming operations. This may be carried out by simply drumming the table with a user's fingertips or by using something like pens or sticks so as to generate the sounds. When compared to operating the keypad for the drumming operations, the non-keypad drumming method offers greater realism and pleasure for the user.

For a microphone array with two microphone units, three virtual drums 501, 502 and 503 may be simulated. To be more specific, after the signal processor 103 determines the direction, distance and/or position of the sound source of the acoustic signals captured by the microphone array, the game controller engine 141 may further determine which virtual drum was played (i.e. hit), accordingly. For example, when the location of the sound source is determined to be close to the left microphone unit Mic 1, the game controller engine 141 determines that the left virtual drum 501 was hit. When the location of the sound source is determined to be in the center of microphone units Mic 1 and Mic 2, the game controller engine 141 may determine that the central virtual drum 502 was hit. Note that when the game controller engine 141 determines that both the left and right virtual drums 501 and 503 were hit at the same time, the operations may be regarded as the central virtual drum 502 being played.

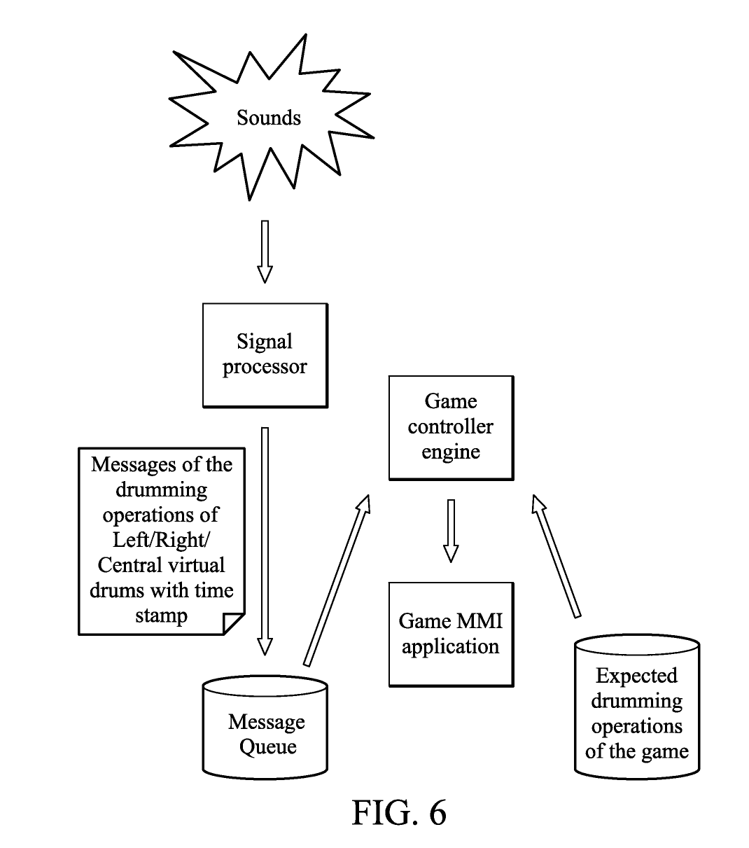

FIG. 6 illustrates a signal processing flow for processing the input acoustic signal of the virtual drumming game according to an embodiment of the invention. After the acoustic signals (i.e. the sounds) are captured by the microphone array and processed by the signal processor 103, one or more characteristics are obtained. For example, the direction, distance and position of the sound source are determined by the signal processor 103. According to the characteristic information, the drumming operations of the left, right or central virtual drums may be judged accordingly. During the microphone signal processing operation, a time stamp of each drumming operation is added thereto. The messages of the drumming operations of the player with a corresponding time stamp are then passed and stored to the message queue for the game controller engine 141. In addition to receiving the drumming operation messages, the game controller engine 141 further retrieves expected drumming operations of the music that the player chooses to perform from a database and compares the drumming operations actually performed by the player with the expected ones so as to compute a score of the game. As previously described, when the player's timing of the drumbeat is correct, points will be earned for the player's score. On the contrary, when the player's timing of the drumbeat is less accurate or miss the drumbeat entirely, points will not be earned or will even be deducted for the player's score.

When the game controller engine compares the drumming operations of the player with the expected drumming operations, information regarding the correct, incorrect, or missed drumming operations of the player analyzed by the game controller engine 141 is generated and further transmitted to the game MMI application unit 142 so as to show the drumming operations of the player in real-time. Table 1 shows an example of the correct answers of the drumming operations of the game (i.e. the expected drumming operations).

TABLE 1
an example of the correct answers of
the drumming operations of the game

| Range of the expected time | Left | Central | Right |
|---|---|---|---|
| to hit the virtual drum | virtual drum | virtual drum | virtual drum |
| 0.9~1.1 second | True | Incorrect | Incorrect |
| 1.4~1.6 second | Incorrect | True | Incorrect |
| 1.9~2.1 second | Incorrect | Incorrect | True |
| 2.4~2.6 second | True | Incorrect | True |

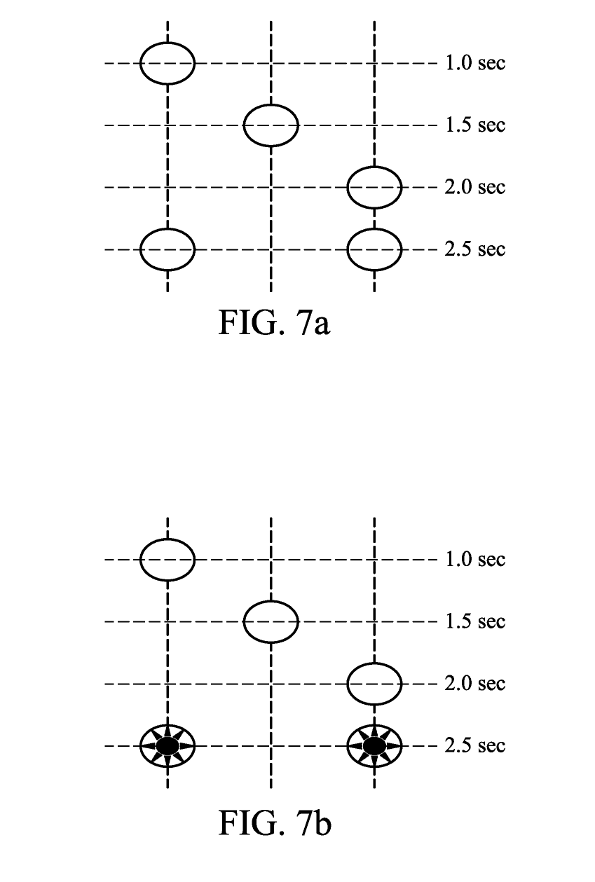

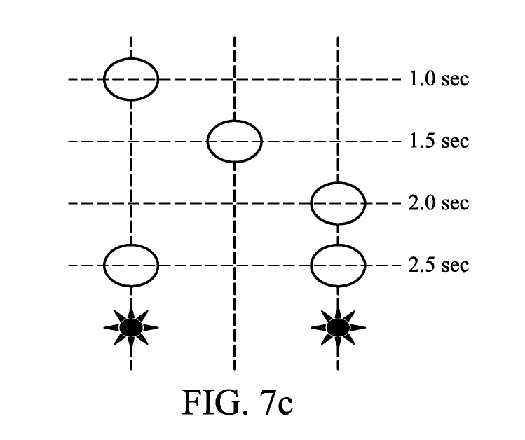

FIG. 7a shows an exemplary scene of a game, which is displayed on a screen 105, which indicates to a player, what the expected drumming operations according to the correct answers shown in Table 1 are. Along with the beat of the song, the scene of the expected drumming operations is displayed on a screen 105 to indicate to a player when he/she should hit the drum(s), so as to earn a high score. FIG. 7b shows an exemplary scene of the game, displayed on a screen 105, which indicates to a player, that a drumbeat was on time. When the game controller engine 141 determines that the player has hit the drumbeat on time, such as within 2.4 to 2.6 seconds, the information is transmitted to the game MMI application unit 142 so as to show the correct drumming operations of the player in real-time. FIG. 7c shows an exemplary scene of the game, displayed on the screen 105, which indicates to a player, a drumbeat was not on time. When the game controller engine 141 determines that the drumbeat of a player was not on time, for example, the left and right drumbeats were initiated some time later than 2.6 second, the information is transmitted to the game MMI application unit 142 so as to show the incorrect drumming operations of the player in real-time.

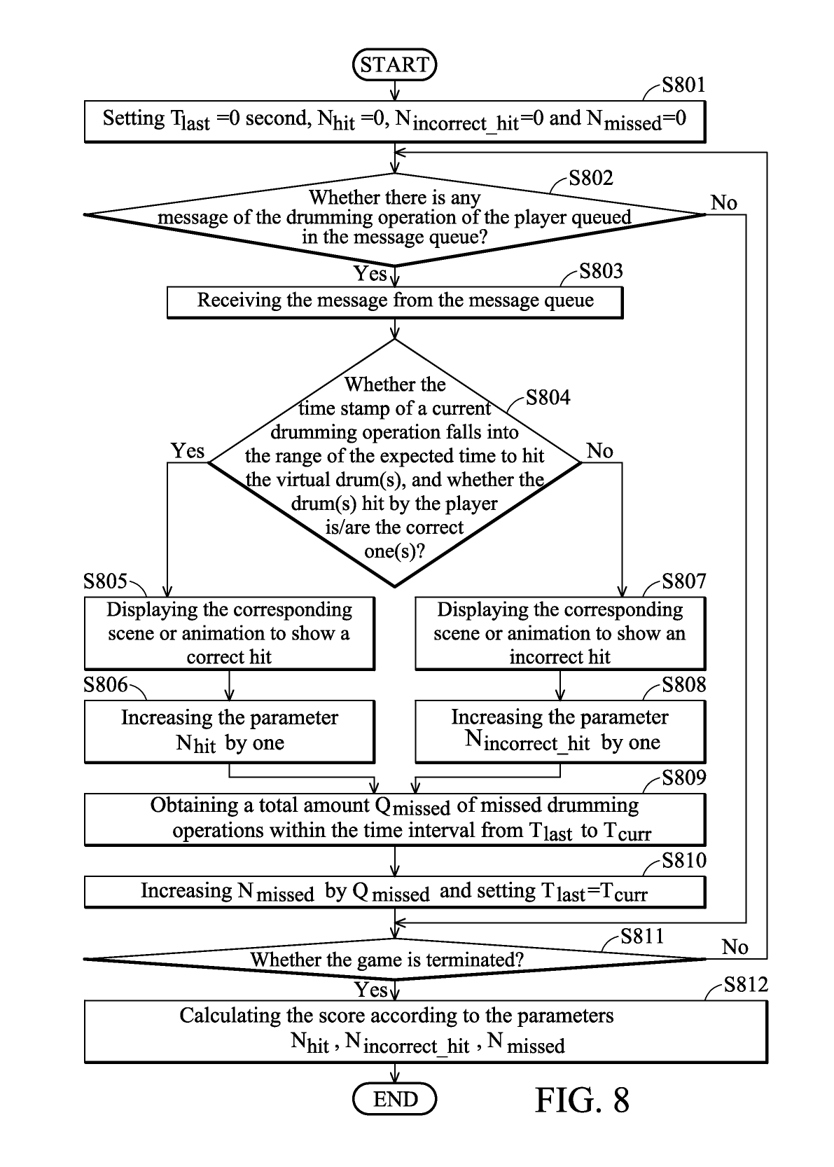

FIG. 8 shows a flow chart of a method for controlling the process of a virtual drumming game according to an embodiment of the invention. In the beginning, the parameters are initialized in Step S801 by setting: Tₗₐₛₜ=0, Nₕᵢₜ=0, N_{incorrect}_{_{—}}ₕᵢₜ=0 and N_{missed}=0, where Tₗₐₛₜ represents the time stamp for a previously detected acoustic signal, Nₕᵢₜ represents the number of correct drumming operations (i.e. the correct drum was hit in time), N_{incorrect}_{_{—}}ₕᵢₜ represents the number of incorrect drumming operations (i.e. the drum that was not supposed to be hit was hit or the drum that was supposed to be hit was not hit within the precise range of time), and N_{missed} represents the number of missed drumming operations (i.e. the correct drum expected to be hit was not hit). Next, the game controller engine 141 determines whether there is any message of the drumming operation of the player queued in the message queue in Step S802. When there is a message queued, the game controller engine 141 receives the message from the message queue in Step S803. Next, the game controller engine 141 determines whether the time stamp T_{curr} of a current drumming operation falls into the range of the expected time to hit the virtual drum(s), and whether the drum(s) hit by the player is/are the correct one(s) in Step S804, where T_{curr} represents the time stamp of a currently detected acoustic signal. When the answer is Yes, the game controller engine 141 directs the game MMI application unit 142 to display the corresponding scene or animation to show a correct hit in Step S805, and increases the parameter Nₕᵢₜ by one in Step S806. On the other hand, when the answer is No, the game controller engine 141 directs the game MMI application unit 142 to display the corresponding scene or animation to show an incorrect hit in Step S807, and increases the parameter N_{incorrect}_{_{—}}ₕᵢₜ by one in Step S808.

The game controller engine 141 further obtains a total amount Q_{missed} of missed drumming operations of the player within the time interval from Tₗₐₛₜ to T_{curr} in Step S809. Next, the game controller engine 141 increases N_{missed} by Q_{missed} and sets Tₗₐₛₜ=T_{curr} in Step S810. After updating the parameters Nₕᵢₜ/N_{incorrect}_{_{—}}ₕᵢₜ, N_{missed} and Tₗₐₛₜ, the game controller engine 141 further determines whether the game should be terminated in Step S811. For example, the game controller engine 141 may determine the game has been terminated when the song is finished. When the game is not terminated, the process returns to Step S802 and the game controller engine 141 determines again whether there is a message of the drumming operation of the player queued in the message queue. When the game is terminated, the game controller engine 141 calculates the score of the player according to the parameters Nₕᵢₜ, N_{incorrect}_{_{—}}ₕᵢₜ, N_{missed} in Step S812. For example, the game controller engine 141 may calculate the score by:

score=Nₕᵢₜ×Sₕᵢₜ−N_{incorrect}_{_{—}}ₕᵢₜ×S_{incorrect}_{_{—}}ₕᵢₜ−N_{missed}×S_{missed} Eq. (14)

where Sₕᵢₜ, S_{incorrect}_{_{—}}ₕᵢₜ, and S_{missed} respectively represents the score of correct, incorrect and missed drumming operations.

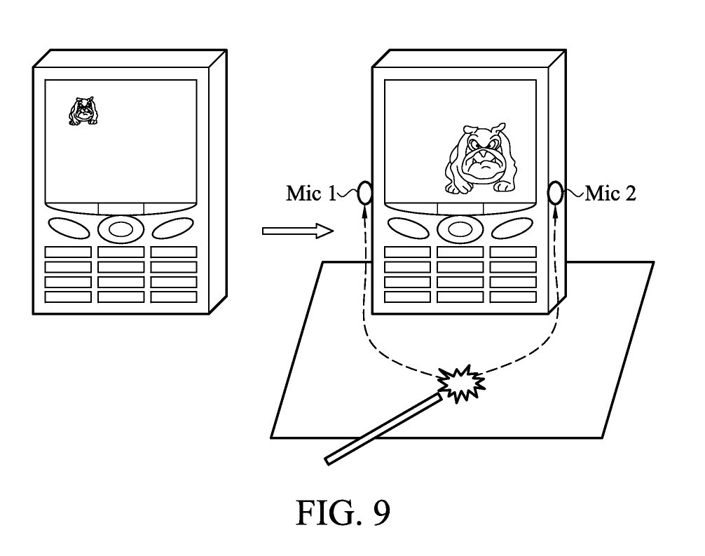

FIG. 9 shows another exemplary game installed in the electronic device that receives acoustic signals as the input signals according to another embodiment of the invention. In the embodiment, the electronic device 100 is installed in a communication apparatus, such as a cellular phone, and the game may be a virtual pet breeding game. The user of the electronic device may interact with the virtual pet by generating sounds. For example, a user (player) may generate sounds on a table with his/her fingertips, or by using something like pens or sticks, or generate sounds by their voice, or even call out a name of a pet so as to generate the sounds to instruct the pet to move closer, change poses, or conduct a specific action. The virtual pet may also move toward the sound source with a speed varied with a distance from the virtual pet to the sound source. The virtual pet may be called an idle mode of the communication apparatus as a screensaver program so as to entertain the user. The user may further interact with the virtual pet by generating different sounds as different instructions to control the motions of the virtual pet.

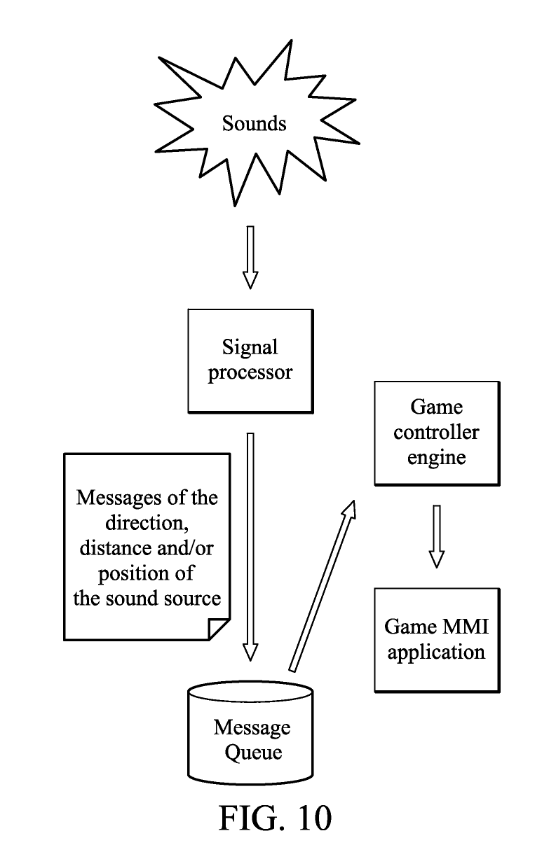

FIG. 10 illustrates a signal processing flow for processing input acoustic signals of the virtual pet breeding game according to an embodiment of the invention. After the acoustic signals (i.e. the sounds) are captured by the microphone array 101 and processed by the signal processor 103, one or more characteristics are obtained. In this embodiment, the direction, distance and/or position of the sound source are determined as the characteristics by the signal processor 103. The message of the direction, distance and/or position of the sound source is then passed to the message queue for the game controller engine 141. The game controller engine 141 determines the motions of the virtual pet according to the direction, distance and/or position of the sound source, generates information regarding the motions and further transmits the information to the game MMI application unit 142 so as to show the motions of the virtual pet on the screen. For example, the game controller engine 141 may change the position, pose, or status of the virtual pet in accordance with the direction, distance and/or position of the sound source, and the game MMI application unit 142 may refresh the scenes of the game so as to display the corresponding scenes or animation showing the change in position, pose, or status of the virtual pet on the screen 105, accordingly.

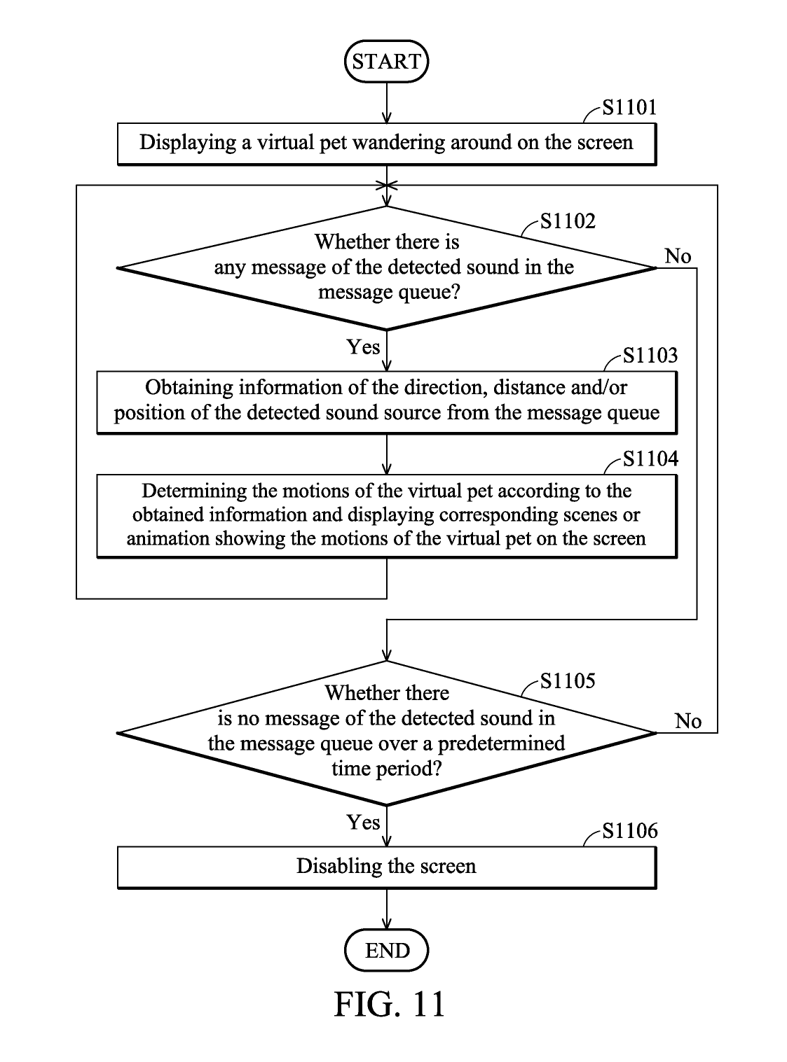

FIG. 11 shows a flow chart of a method for controlling the process of a virtual pet breeding game according to an embodiment of the invention. In the beginning, when the communication apparatus enters an idle mode, an application program of the virtual pet breeding game may be executed, and the game MMI application unit 142 may draw and display the animation of a virtual pet wandering around on the screen 105 in Step S1101. The game controller engine 141 then determines whether there is any message of the detected sound in the message queue in Step S1102. When there is a message in the message queue, the game controller engine 141 obtains information of the direction, distance and/or position of the detected sound source from the message queue in Step S1103. Next, the game controller engine 141 determines the motions of the virtual pet according to the direction, distance and/or position of the sound source, generates information regarding the motions and further transmits the information to the game MMI application unit 142 so as to display the corresponding scenes or animation showing the motions of the virtual pet on the screen in Step S1104. Next, the process returns to Step S1102 to determine whether there is any new message of the detected sound in the message queue.

When there is no new messages of the detected sound in the message queue, the game controller engine 141 further determines whether there is no message of the detected sound in the message queue over a predetermined time period in Step S1105. If the answer is No, the process returns to Step S1102 to determine whether there is any new message of the detected sound in the message queue. If the answer is Yes, the game controller engine 141 may disable the screen 105 for power saving in Step S1106. For example, the backlight of the screen 105 may be turned off for power saving. According to the embodiment of the invention, instead of using the keys on the keypad to control the virtual pet, the player generates sounds that will be captured by the microphone array of the electronic device as the instructions to control the virtual pet. In this manner, the new interface may provide more possible ways for interaction between users and virtual pets and attract more users to play the game.

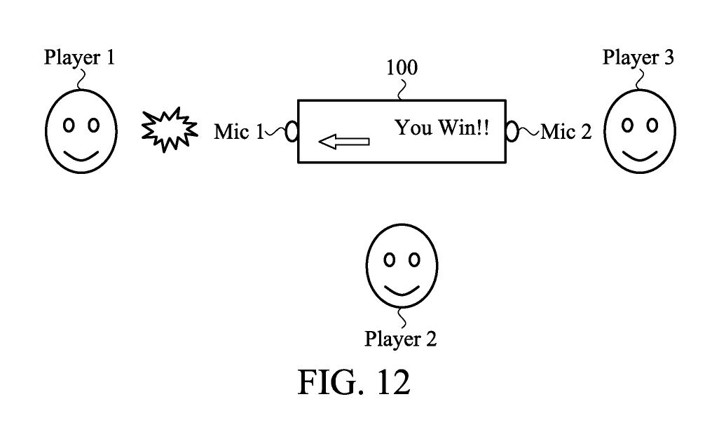

FIG. 12 illustrates another exemplary game installed in the electronic device that receives acoustic signals as the input signals according to another embodiment of the invention. In the embodiment, the electronic device 100 is installed in a communication apparatus, such as a cellular phone, and the game may be a sound judger to judge which player, among multiple players, has the fastest response to generate a sound. According to an embodiment of the invention, the sound judger game may process beating or drumming sounds of multiple players (or users, such as player 1 to play 3 shown in FIG. 12) as input signals. For example, the beating or drumming sounds may be generated by hitting a table with the palms of the player's hands. The signal processor 103 may determine the timing of the beating or drumming sounds of different players according to the acoustic signals captured by the microphone array 101, and the game controller engine 141 may further determine a winner of the game. For example, after the game begins, the signal processor 103 may determine the direction or position of the sound sources, and pass the messages of the detected sounds to the game controller engine 141. After receiving the information, the game controller engine 141 determines which sound source has generated the earliest beat or drum sound. As shown in FIG. 12, when the earliest beat or drum sound captured by the microphone array 101 is generated by player 1, the game controller engine 141 may determine that player 1 is the winner of the game.

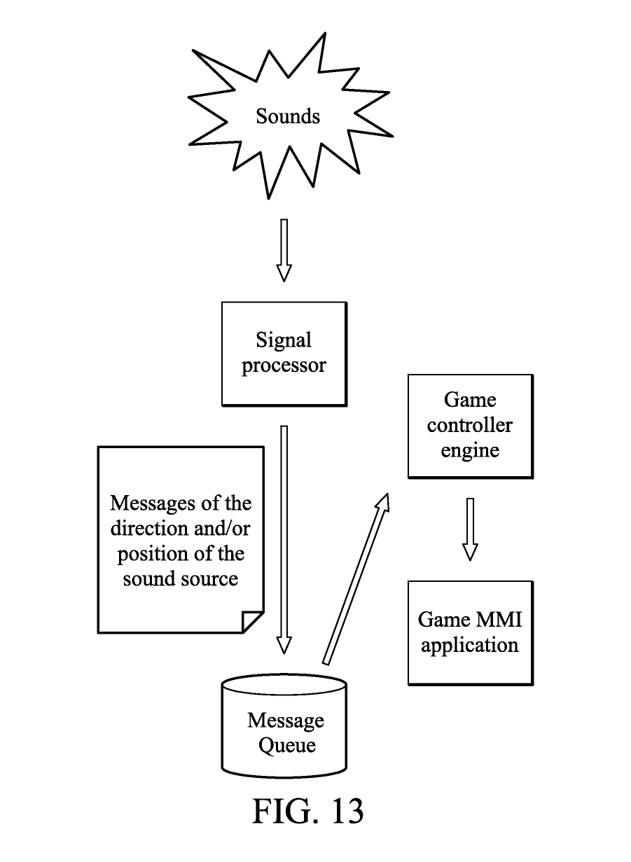

FIG. 13 illustrates a signal processing flow for processing input acoustic signal of the sound judger game according to an embodiment of the invention. After the acoustic signals (i.e. the sounds) are captured by the microphone array 101 and processed by the signal processor 103, one or more characteristics are obtained. In this embodiment, the directions and/or positions of multiple sound sources are determined as the characteristics by the signal processor 103. The messages of the directions and/or positions of the sound sources are then passed to a message queue for the game controller engine 141. During the microphone signal processing operation, time stamps of the captured sounds are provided. The messages of directions and/or positions of the detected sounds with corresponding time stamps are then passed to the message queue for the game controller engine 141. After receiving the messages, the game controller engine 141 determines which sound source has generated the earliest sound, and generates information regarding the earliest one to the game MMI application unit 142 so as to display corresponding scenes or animation showing which player is the winner of the game on the screen. Finally, the game MMI application unit 142 may refresh the scenes of the game so as to display results of the game, accordingly.

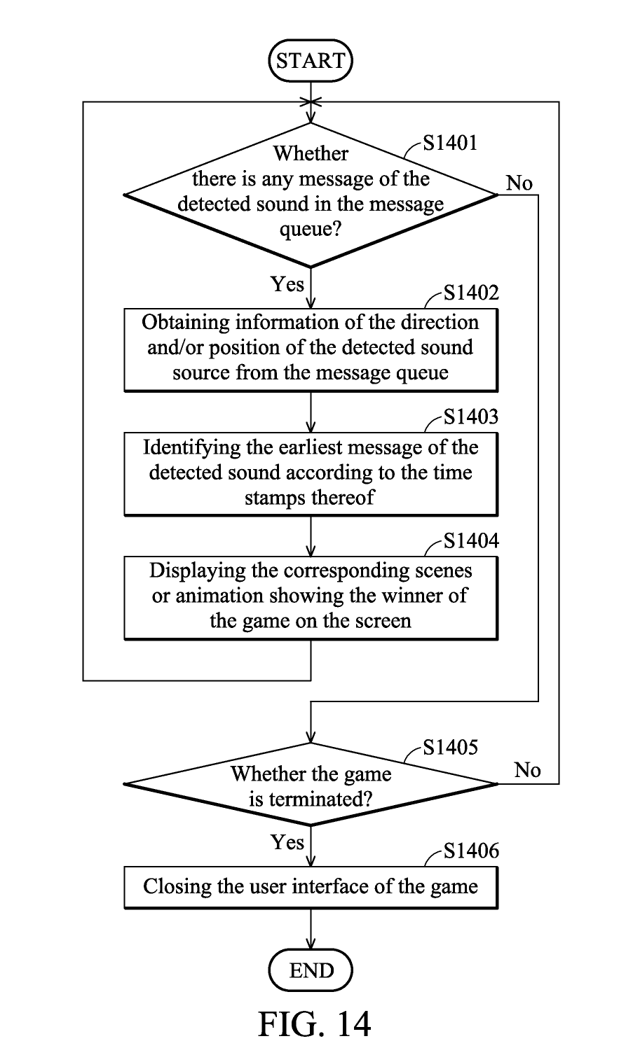

FIG. 14 shows a flow chart of a method for controlling the process of a sound judger game according to an embodiment of the invention. After the game begins, the game controller engine 141 determines whether there is any message of the detected sound in the message queue in Step S1401. When there is a message in the message queue, the game controller engine 141 obtains information of the direction and/or position of the detected sound source from the message queue in Step S1402. Next, the game controller engine 141 identifies the earliest message of the detected sound according to the time stamps thereof so as to determine the winner of the game in Step S1403. The game controller engine 141 may generate information regarding the winner of the game and further transmit the information to the game MMI application unit 142 so as to display the corresponding scenes or animation showing who is the winner of the game on the screen in Step S1404. Next, the process returns to Step S1401 to determine whether there is any new message of the detected sound in the message queue.

When there is no new message of the detected sound in the message queue, the game controller engine 141 further determines whether the game has been terminated by the user in Step S1405. If the answer is No, the process returns to Step S1401 to determine whether there is any new message of the detected sound in the message queue. If the answer is Yes, the game controller engine 141 may shut down the user interface of the game in Step S1406. According to the embodiment of the invention, instead of pressing the keys on the keypad to play the game, the players may use their hands or body to generate sounds. This may be carried out by simply hitting the table with a player's palm so as to generate sounds. When comparing to playing this kind of judger game on keypad or touch screen, the sound judger game offers greater realism and convenience for players.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a microphone array, comprising at least a first microphone unit for capturing at least a first acoustic signal and a second microphone unit for capturing at least a second acoustic signal;
a signal processor, processing the first and second acoustic signals and obtaining at least one characteristic from the first and second acoustic signals; and
a game controller, updating at least one parameter of a game in accordance with the at least one characteristic and thereby controlling a process of the game.

2. The electronic device as claimed in claim 1, wherein the at least one characteristic comprises one or a combination of a time difference of arrival (TDOA) between the first acoustic signal and the second acoustic signal captured by the microphone array, a direction of at least a sound source generating the first or the second acoustic signals, a distance from the microphone array to the sound source, and/or a position of the sound source.

3. The electronic device as claimed in claim 2, wherein the signal processor obtains the time difference of arrival between the first and second acoustic signals captured by the microphone array according to a cross-correlation therebetween.

4. The electronic device as claimed in claim 2, wherein the signal processor obtains the direction of the sound source by determining an incident angle of the first acoustic signal and/or second acoustic signal according to the time difference of arrival.

5. The electronic device as claimed in claim 2, wherein the signal processor obtains the distance from the microphone array to the sound source according to the direction of the sound source, amplitudes of the first acoustic signal and the second acoustic signal, and a distance between the first microphone unit and the second microphone unit.

6. The electronic device as claimed in claim 2, wherein the signal processor obtains the position of the sound source according to the direction of the sound source and the distance from the microphone array to the sound source.

7. The electronic device as claimed in claim 1, wherein the game processes drumming sounds performed by a user as input signals.

8. The electronic device as claimed in claim 7, wherein the signal processor determines drumming operations of the user according to the at least one characteristic, and the game controller compares the drumming operations of the user with expected drumming operations of the game so as to compute a score of the game.

9. The electronic device as claimed in claim 1, further comprising:
a screen, displaying scenes of the game,
wherein the parameter of the game comprises a position of an object of the game to be displayed on the screen, and wherein the game controller further refreshes the scenes of the game in response to the updated parameter.

10. The electronic device as claimed in claim 1, wherein the game processes drumming sounds of multiple users as input signals, the signal processor determines timing of the drumming sounds of different users according to the at least one characteristic, and the game controller determines a winner of the game generating the earliest drumming sound among the users.

11. A method for controlling a process of a game installed in an electronic device with a microphone array, comprising:
receiving a plurality of acoustic signals via the microphone array as input signals of the game;
processing the acoustic signals to obtain at least one characteristic from the acoustic signals; and
updating at least one parameter of the game in accordance with the at least one characteristic; thereby controlling the process of the game.

12. The method as claimed in claim 11, wherein the microphone array comprises at least two microphone units, the plurality of acoustic signals comprises at least a first acoustic signal and a second acoustic signal respectively captured by the different microphone units, and the at least one characteristic comprises a time difference of arrival (TDOA) between the first acoustic signal and second acoustic signal captured by the microphone array, a direction of at least a sound source generating the first or second acoustic signals, a distance from the microphone array to the sound source, and/or a position of the sound source.

13. The method as claimed in claim 11, wherein the parameter of the game comprises a score or record of the game, an instruction recognized in accordance with the at least one characteristic for controlling the game, or a position or a status of an object of the game to be displayed on a screen of the electronic device.

14. The method as claimed in claim 12, wherein the time difference of arrival between the first and second acoustic signals is obtained according to a cross-correlation therebetween.

15. The method as claimed in claim 12, wherein the direction of the sound source is obtained by determining an incident angle of the first acoustic signal or second acoustic signal according to the time difference of arrival.

16. The method as claimed in claim 12, wherein the distance from the microphone array to the sound source is obtained according to the direction of the sound source, amplitudes of the acoustic signals, and a distance between the microphone units.

17. The method as claimed in claim 12, wherein the position of the sound source is obtained according to the direction of the sound source and the distance from the microphone array to the sound source.

18. The method as claimed in claim 11, wherein the acoustic signals are drumming sounds performed by at least one user playing the game, and the method further comprises:
determining drumming operations of the user according to the at least one characteristic;
comparing the drumming operations of the user with expected drumming operations of the game to obtain a plurality of comparison results; and
computing a score of the game according to the comparison results.

19. The method as claimed in claim 11, wherein the acoustic signals are generated by a user playing the game, the user generates the acoustic signals as different instructions to control a plurality of motions of an object of the game, and the method further comprises:
determining the motions of the object according to the at least one characteristic; and
displaying an animation to show the determined motions of the object on a screen of the electronic device.

20. The method as claimed in claim 11, wherein the acoustic signals are drumming sounds performed by multiple users playing the game, and the method further comprises:
determining timing of the drumming sounds of different users according to the at least one characteristic; and
determining a winner of the game generating the earliest drumming sound among the users.
